(19) United States
(12) Patent Application Publication
(10) Pub. No.: US 2014/0310915 A1
(43) Pub. Date: Oct. 23, 2014

(54) HOLDING HINGE ASSEMBLY

(71) Applicant: Marine Town Inc., New Taipei City (TW)

(72) Inventor: Chin-Chung TUNG, New Taipei City (TW)

(21) Appl. No.: 14/027,998

(22) Filed: Sep. 16, 2013

Related U.S. Application Data
(60) Provisional application No. 61/855,404, filed on Apr. 17, 2013.

(51) Int. Cl. E05D 11/08

(52) U.S. Cl. CPC E05D 11/08
USPC 16/342

(57) ABSTRACT

A holding hinge assembly provided is for being installed between, for example, a jamb and a hatch. The holding hinge assembly includes a pivotal pin; and at least one hinge leaf having a pivotal hole for frictionally, rotatably receiving the pivotal pin so that a friction exists between an inner wall of the pivotal hole and a periphery of the pivotal pin, and the hatch is allowed to rotate with respect to the jamb when receiving an external force applied thereon that is sufficient to surpass the friction. The friction provides a resistance to prevent or at least hinder the hatch from rotating with respect to the jamb under gravity or rebounding inertia. Thereby, the holding hinge assembly can hold the hatch at its opened position without using any additional hardware, so as to save costs and space.

### BACKGROUND OF THE INVENTION

1. Technical Field

The present invention relates to hinges, and more particularly, to a holding hinge assembly that is able to hold itself at an opened position and thereby hold a door having it at an opened position without using any additional hardware.

2. Description of Related Art

Hinges have been extensively used for movable assemblies, like hatches, doors and casements. However, the conventional hinge provides no means to hold itself, and in turn a door using it as a pivotal means, at opened positions thereof. When the door is an overhead one, a user who wants to access an overhead cabinet therethrough can only have his/her one hand free to reach the cabinet as his/her the other hand has to hold the door open. As a known approach to holding a door open, a strut or a gas cylinder may be used with the hinge. This known approach nevertheless is far from perfection because additional hardware means additional costs and spacial consumption. Moreover, such additional spacial consumption is particularly unacceptable for those applications associated with limited space, such as installation in a cabinet or a boat.

Hence, there is a need for a holding hinge assembly that is able to hold itself at an opened position and thereby hold a door at an opened position without using any struts or gas cylinders.

### SUMMARY OF THE INVENTION

In view of the need as described above, one objective of the present invention is to provide a holding hinge assembly that is able to hold itself at an opened position and thereby hold a door having it at an opened position without using any additional hardware.

Another objective of the present invention is to provide a holding hinge assembly, which allows the door having it to be easily opened and prevented or at least hindered from being closed under gravity or rebounding inertia of the door.

For achieving the above and other objectives, a holding hinge assembly to be installed between a relatively irremovable member and a relatively movable member according to the present invention comprises: a pivotal pin; and at least one hinge leaf having a pivotal hole for frictionally, rotatably receiving the pivotal pin so that a friction exists between an inner wall of the pivotal hole and a periphery of the pivotal pin, and the relatively movable member is allowed to rotate with respect to the relatively irremovable member when receiving an external force applied thereon that is sufficient to surpass the friction. When the hinge leaf rotates about the pivotal pin toward a first direction, a first friction is produced between the hinge leaf and the pivotal pin; when the hinge leaf rotates about the pivotal pin toward a second direction, a second friction is produced between the hinge leaf and the pivotal pin.

Also provided is a holding hinge as described further having the first friction greater than the second friction, and the first direction is a direction of the relatively movable member rotating toward the relatively irremovable member for opening, while the second direction is an opposite direction of the relatively movable member rotating toward the relatively irremovable member for closing.

Also provided is a holding hinge as described further having the pivotal pin made of a first material possessing a pin diameter, while the hinge leaf is made of a second material and has a hole diameter of the pivotal hole slightly smaller than the diameter of the pin diameter, in which the first material is slightly more elastic than the second material so as to allow the pivotal pin to be frictionally, rotatably received in the pivotal hole.

Also provided is a holding hinge as described further having a first hinge leaf installed on the relatively movable member and a second hinge leaf installed on the relatively irremovable member.

Also provided is a holding hinge as described further having the first hinge leaf possessing a leaf body to be installed on the relatively movable member and a barrel portion defining the pivotal hole that the barrel portion is extended and curved outward from the leaf body to have a C-shaped section so that a slot is left on the barrel portion.

Also provided is a holding hinge as described further having a connecting part and a distal end located on the two sides of the slot of the barrel portion, wherein the connecting part is connected to the leaf body, and located on one side defined by a direction of the first hinge leaf rotating toward the first direction.

Also provided is a holding hinge as described further having the inner wall of the pivotal hole of the first hinge leaf being a smooth surface.

Also provided is a holding hinge as described further having the second hinge leaf possessing a leaf body to be installed on the relatively irremovable member and a barrel portion defining the pivotal hole, while the inner wall of the pivotal hole is a rough surface.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a holding hinge according to one preferred embodiment of the present invention;

FIG. 2 is an exploded view of the holding hinge of FIG. 1;

FIG. 3 is a side view of a second hinge leaf in the holding hinge of FIG. 1;

FIG. 4 is a side view of a first hinge leaf in the holding hinge of FIG. 1;

FIG. 5 is a cross-sectional view of the holding hinge of FIG. 1 taken along Line 5-5;

FIG. 6 is a cross-sectional view of the holding hinge of FIG. 1 taken along Line 6-6;

FIG. 7 is a schematic view of the first hinge leaf of the holding hinge rotating toward a first direction;

FIG. 8 is a schematic view of the first hinge leaf of the holding hinge rotating toward a second direction; and

FIGS. 9-11 are applied views of the holding hinge of FIG. 1 applied on the irremovable member and the relatively movable member.

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiment, people would further understand the technical means and effects the present invention adopts to achieve the above-indicated objectives. However, the accompanying drawings are intended for reference and illustration, but not to limit the present invention and are not made to scale.

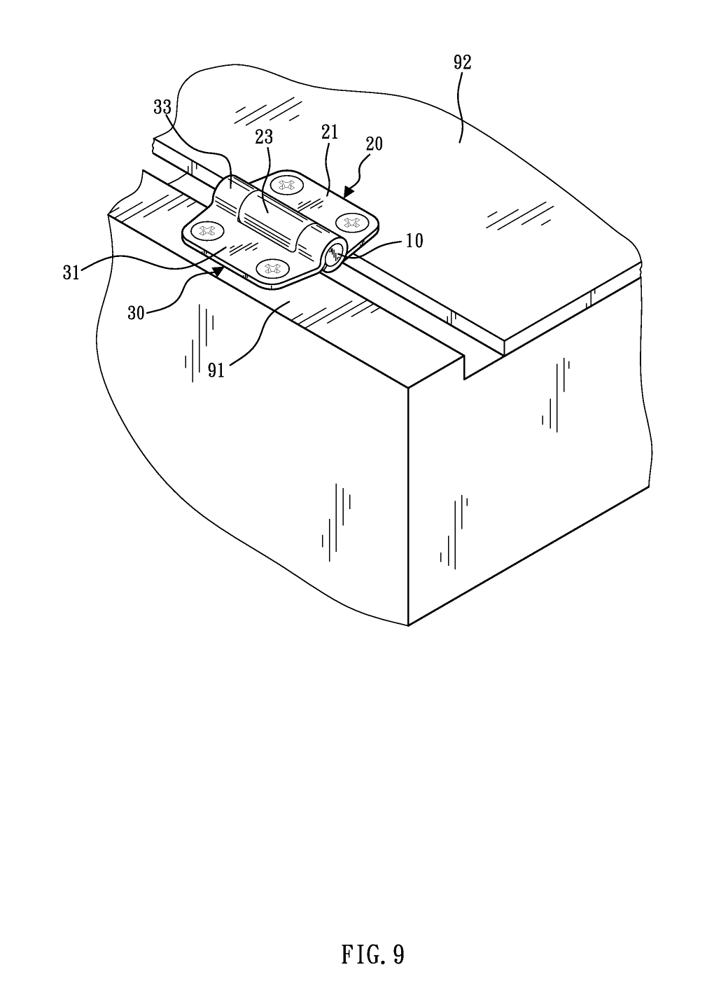

According to one preferred embodiment of the present invention, a holding hinge assembly 100 is to be installed between a relatively irremovable member 91 and a relatively movable member 92, such as a jamb and a hatch on a boat deck, respectively, as shown in FIGS. 9-11.

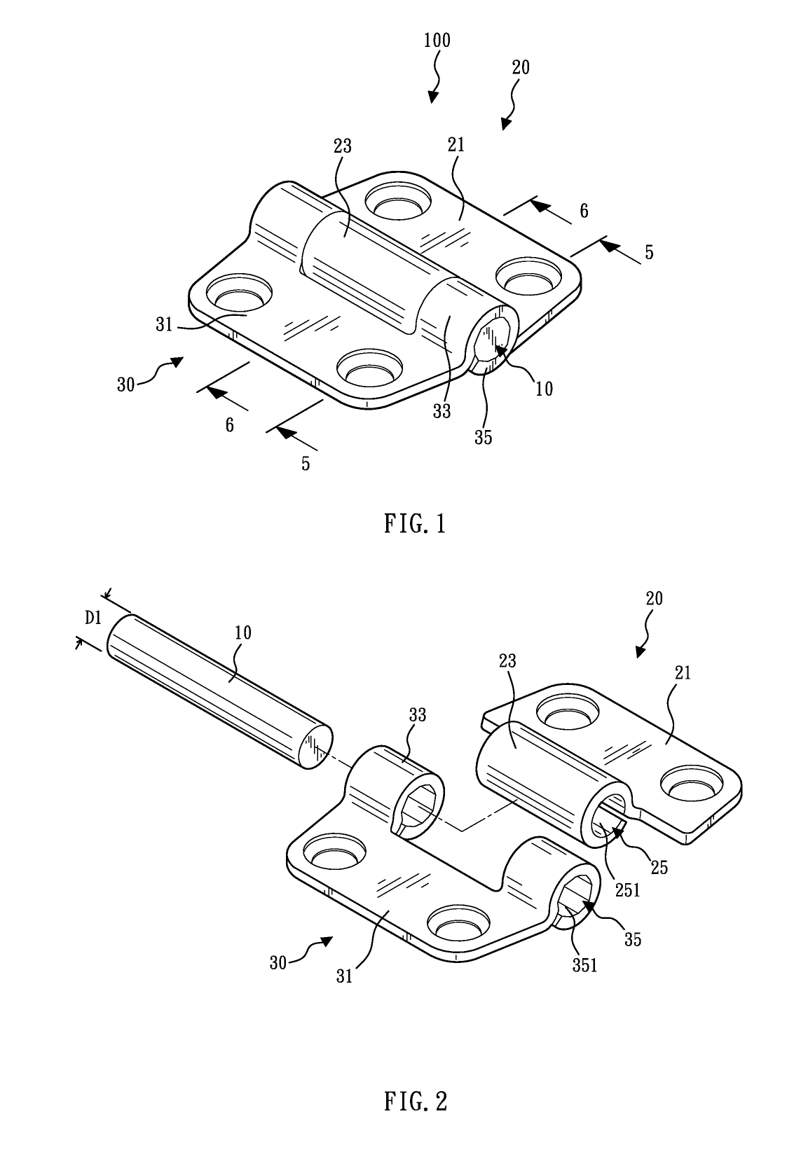

Now referring to FIGS. 1-4, the depicted holding hinge assembly 100 has a pivotal pin 10, a first hinge leaf 20 and a second hinge leaf 30. Each of the first and second hinge leaves 20, 30 has a leaf body 21 or 31, and one or more barrel portions 23 or 33 defining a pivotal hole 25, 35 therein. It is to be noted that the pivotal pin 10 has a pin diameter Dl. The first hinge leaf 20 has a hole diameter D2 of the pivotal hole 25 that is slightly smaller than the pin diameter D1. The pivotal hole 35 of the second hinge leaf 30 has a hole diameter D3 of the pivotal hole 35 that is slightly smaller than the pin diameter Dl. Thereby, the pivotal hole 25, 35 is permanently, tightly fitting with the surface of the pivotal pin 10.

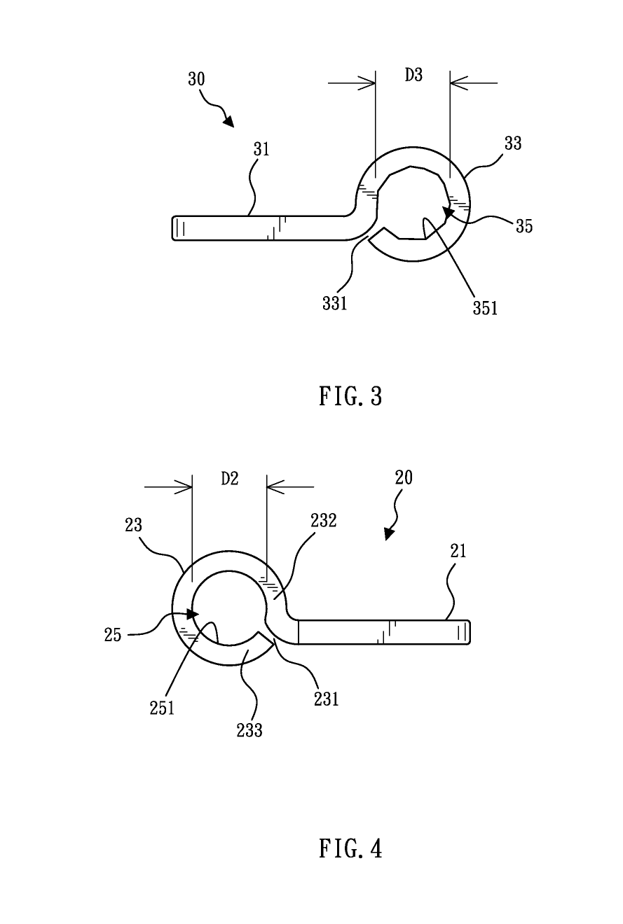

As can be seen in FIG. 3, the pivotal hole 35 of the second hinge leaf 30 has a rough inner wall 351 formed directly from a stamped, unpolished metal sheet. In this manner, an additional friction exists between the inner walls 351 of the pivotal hole 35, making the pivotal pin 10 fixed with the inner wall 351 of the pivotal holes 35, thereby prevented from relatively rotating in the pivotal holes 35.

By comparison, as depicted in FIG. 4, the pivotal hole 25 of the first hinge leaf 20 has a relatively smooth inner wall 251, which is a result of, for example, a polishing process conducted on a metal sheet after the metal sheet is stamped and rolled up into the barrel portion 23. This smooth surface of the inner wall 251 allows the pivotal pin 10 to rotate therein relatively freely, as compared to the inner wall 351 of the second hinge leaf 30.

The pivotal pin 10 is made of a first material while the first and second hinge leaves 20, 30 are made of a second material, in which the first material is slightly more elastic, or less rigid, than the second material. In one embodiment of the present invention, the first material is a plastic resin and the second material is a metal that is stiffer than the plastic resin used for making the pivotal pin 10. Thereby, the pivotal pin 10 can be frictionally, rotatably received in the pivotal holes 25, 35.

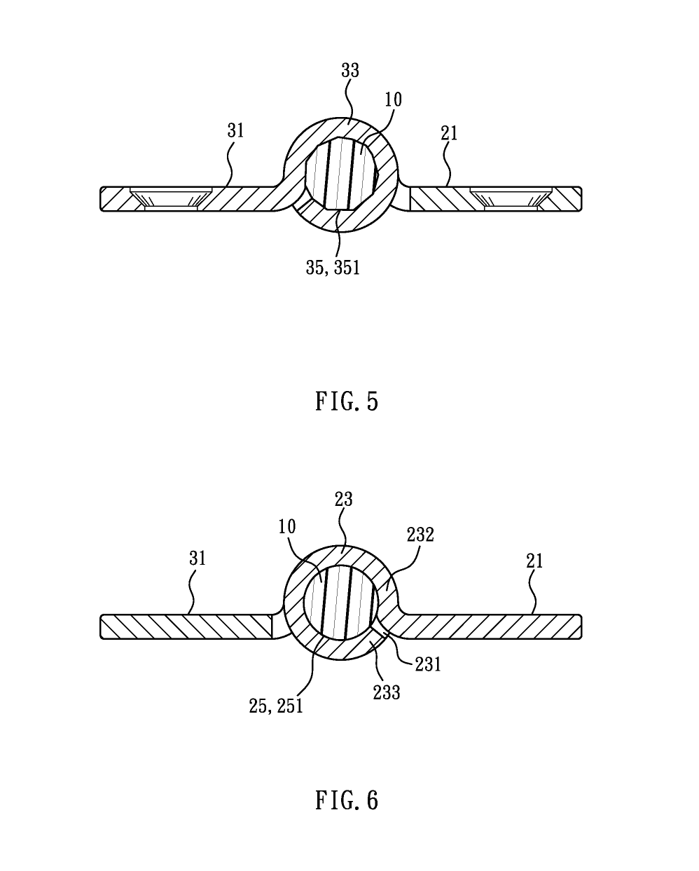

The second hinge leaf 30 as shown in FIGS. 3, 5 and 9 is installed on the relatively irremovable member 91 with its barrel portion 33 extended and curved outward to the leaf body 31 to have a C-shaped section so that a slot 331 is left on the barrel portion 33.

Referring to FIGS. 4 and 6-9, the first hinge leaf 20 installed on the relatively movable member 92, wherein the barrel portion 23 is extended and curved outward to the leaf body 21 to have a C-shaped section so that a slot 231 is left on the barrel portion 23.

Thereby, the holding hinge assembly 100 can be applied simultaneously on the relatively movable member 92 and the relatively irremovable member 91 as an axis for rotationally opening or closing such structure.

When the first hinge leaf 20 rotates about the pivotal pin 10 toward a first direction A together with the relatively movable member 92, a first friction is produced between the first hinge leaf 20 and the pivotal pin 10. When the first hinge leaf 20 rotates about the pivotal pin 10 toward a second direction B, a second friction is produced between the first hinge leaf 20 and the pivotal pin 10. Therein, the first direction A is the direction of the relatively movable member 92 rotating for opening against the relatively irremovable member 91, and the second direction B is the direction of the relatively movable member 92 rotating for closing against the relatively irremovable member 91. The first direction A and the second direction B, with the pivotal pin 10 as the rotational axle, are opposite to each other.

Therein, as shown in FIGS. 4 and 6-8, a connecting part 232 and a distal end 233 are located on the two sides of the slot 231 of the barrel portion 23. The connecting part 232 is connected to the leaf body 21, and located on one side defined by the direction of the first hinge leaf 20 rotating toward the first direction A.

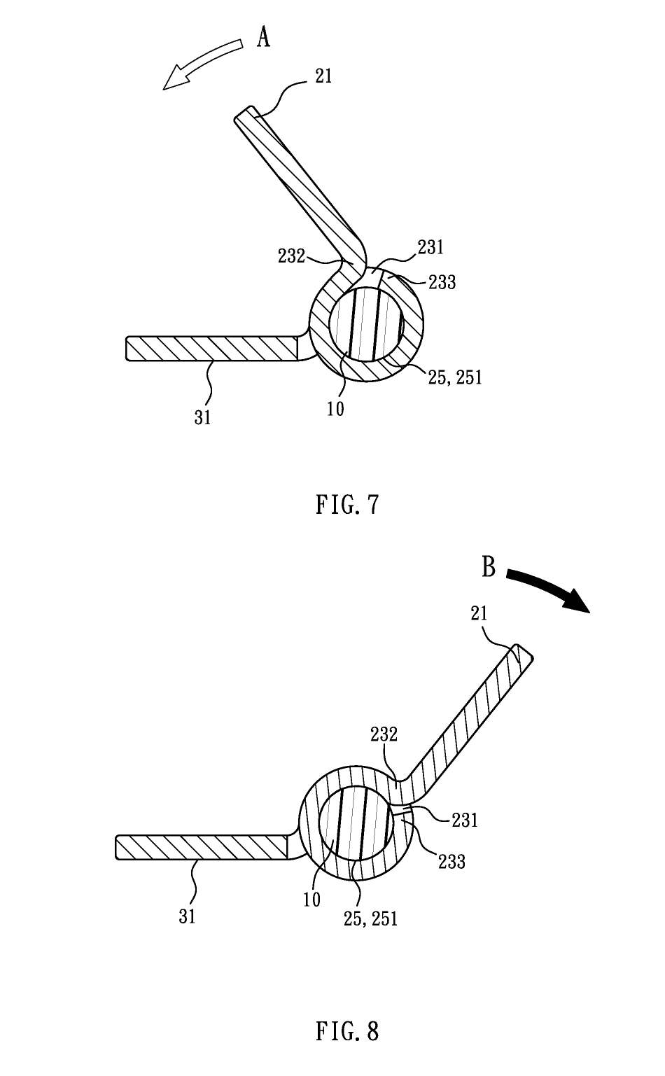

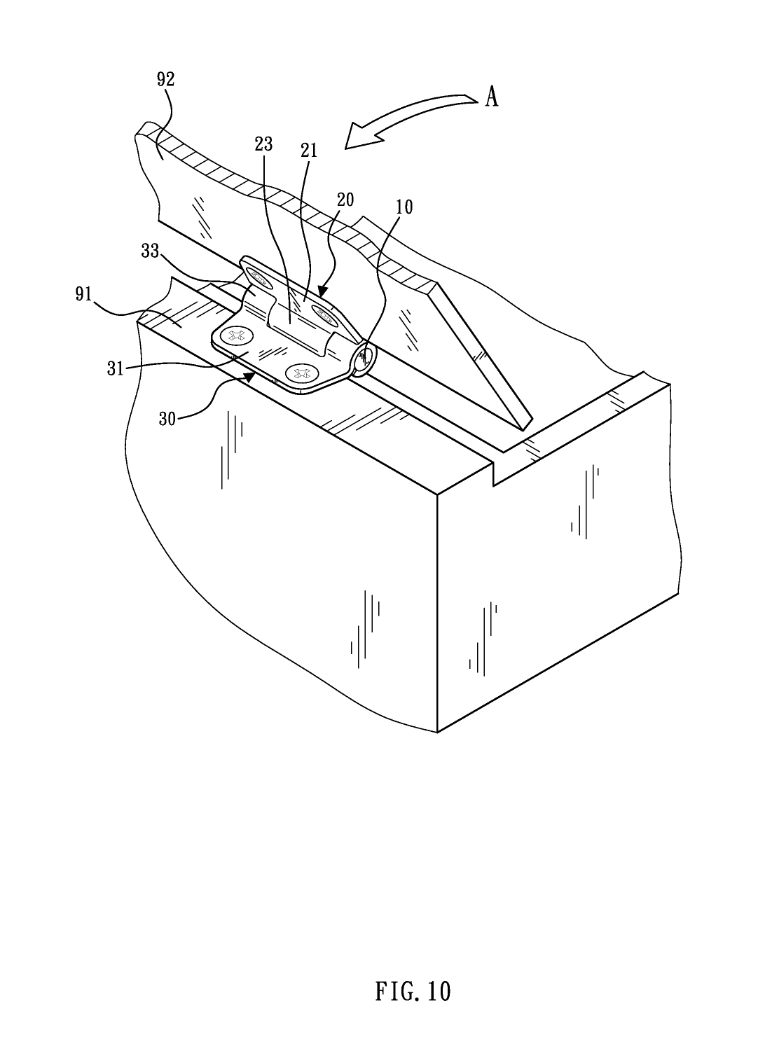

As shown in FIGS. 7 and 10, when relative movable member 92 receives an external force and rotates toward the first direction A, based on the fact that the pivotal hole 35 of the second hinge leaf 30 is present as a rough inner wall 351, and the pivotal hole 25 of the first hinge leaf 20 is present as a smooth inner wall 251, the pivotal pin 10 is thereby fixed inside the pivotal holes 35 and prevented from relatively rotating, while the barrel portion 23 of the first hinge leaf 20 is forced to rotate toward the first direction A with the pivotal pin 10 as an axle.

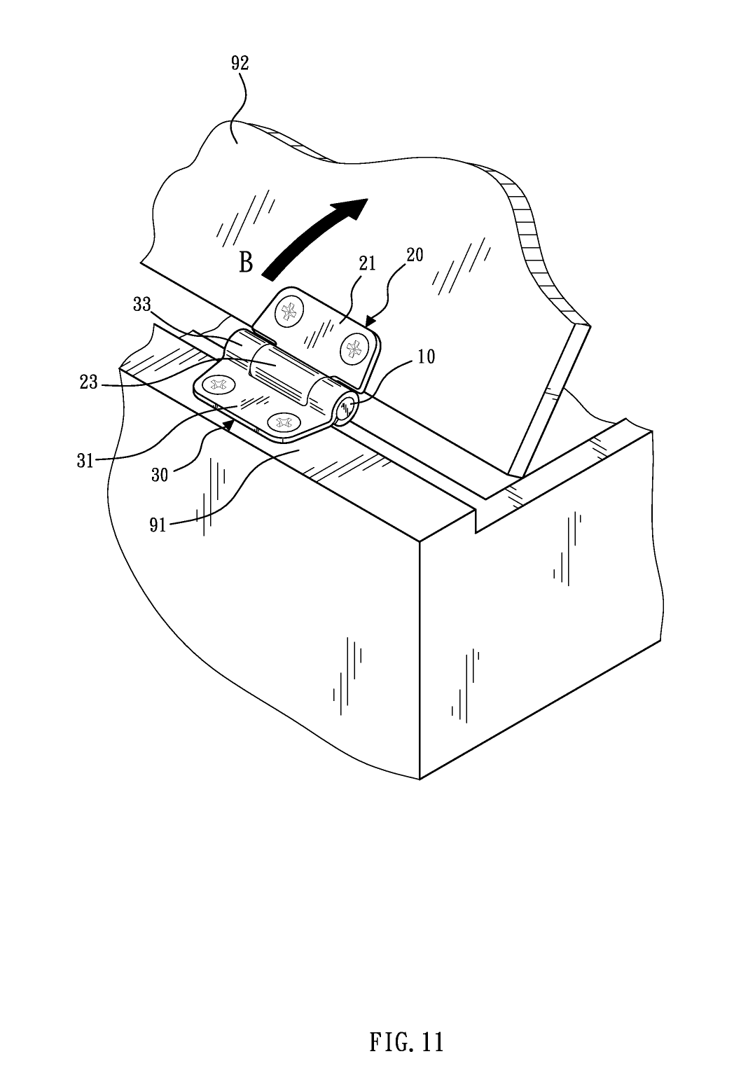

However, because the hole diameter D2 of the pivotal hole 25 is slightly smaller than the pin diameter D1, pivotal hole 25 is constantly, tightly fitting with the surface of the pivotal pin 10, whereby a opposite friction is produced between the barrel portions 23 and the pivotal pin 10 when the barrel portion 23 and the pivotal pin 10 are about to rotate against each other. Therefore, when the barrel portion 23, with the pivotal pin 10 as an axle, rotates toward the first direction A, the opposite friction causes the distal end 233 to stay put, while the connecting part 232 bends outward due to the force exerted by the relatively movable member 92, expanding the slot 231, enlarging the hole diameter D2 of the pivotal hole 25, and thus decreasing the friction between the barrel portion 23 and the pivotal pin 10. In contrast, as shown in FIGS. 8 and 11, when the relatively movable member 92 and the first hinge leaf 20 rotate toward the second direction B, the opposite friction causes the distal end 233 to stay put, while the connecting part 232 bends inward due to the force exerted by the relatively movable member 92, shrinking the slot 231, decreasing the hole diameter D2 of the pivotal hole 25, and thus increasing the friction between the barrel portion 23 and the pivotal pin 10. Thereby, difference of friction of the holding hinge assembly 100 rotating toward different directions is provided.

The present invention creates the first direction A, the direction of the relatively movable member 92 rotating toward the relatively irremovable member 91 for opening, and the second direction B, the direction of the relatively movable member 92 rotating away from the relatively irremovable member 91 for closing, thus achieving the feature of “easy for opening and difficult for closing ” for user applications.

Thereby, the holding hinge assembly of the present invention can hold a door (or a hatch, a cabinet door or the like) at its opened position so that a user can easily access the space behind (or below) the door with both of his/her hands. This advantage can be achieved without using any additional hardware, so as to save costs and space.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A holding hinge assembly to be installed between a relatively irremovable member and a relatively movable member, the holding hinge assembly comprising:
a pivotal pin; and
at least one hinge leaf having a pivotal hole for frictionally, rotatably receiving the pivotal pin so that a friction exists between an inner wall of the pivotal hole and a periphery of the pivotal pin, and the relatively movable member is allowed to rotate with respect to the relatively irremovable member when receiving an external force applied thereon that is sufficient to surpass the friction,
wherein a first friction is produced between the hinge leaf and the pivotal pin when the hinge leaf rotates about the pivotal pin toward a first direction, and a second friction is produced when the hinge leaf rotates about the pivotal pin toward a second direction.

2. The holding hinge assembly of claim 1, wherein the first friction is greater than the second friction, and the first direction is a direction of the relatively movable member rotating toward the relatively irremovable member for opening, while the second direction is an opposite direction of the relatively movable member rotating away from the relatively irremovable member for closing.

3. The holding hinge assembly of claim 1, wherein the pivotal pin is made of a first material and has a pin diameter, while the hinge leaf is made of a second material and has a hole diameter of the pivotal hole slightly smaller than the diameter of the pin diameter, in which the first material is slightly more elastic than the second material so as to allow the pivotal pin to be frictionally, rotatably received in the pivotal hole.

4. The holding hinge assembly of claim 1, wherein the hinge leaf comprises a first hinge leaf installed on the relatively movable member and a second hinge leaf installed on the relatively irremovable member.

5. The holding hinge assembly of claim 4, wherein the first hinge leaf has a leaf body to be installed on the relatively movable member and has a barrel portion defining the pivotal hole that the barrel portion is extended and curved outward from the leaf body to have a C-shaped section so that a slot is left on the barrel portion.

6. The holding hinge assembly of claim 4, wherein a connecting part and a distal end are located on the two sides of the slot of the barrel portion, wherein the connecting part is connected to the leaf body, and located on one side defined by a direction of the first hinge leaf rotating toward the first direction.

7. The holding hinge assembly of claim 4, wherein the inner wall of the pivotal hole of the first hinge leaf is a smooth surface.

8. The holding hinge assembly of claim 4, wherein the second hinge leaf has a leaf body to be installed on the relatively irremovable member and has a barrel portion defining the pivotal hole, and the inner wall of the pivotal hole is a rough surface.
